(19) United States
(12) Patent Application Publication
(10) Pub. No.: US 2004/0264027 A1
(43) Pub. Date: Dec. 30, 2004

(54) Movable information processing device, information processing method and storage medium

(75) Inventor: Tomohiro Nishio, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/859,076

(22) Filed: Jun. 3, 2004

(30) Foreign Application Priority Data
Jun. 26, 2003 (JP) 2003-183206

(51) Int. Cl. G11B 19/04; G11B 19/02

(52) U.S. Cl. 360/60; 360/69

(57) ABSTRACT

A movable information processing device which is provided with check means that checks whether or not both of moving distance information of the information processing device, which are stored in storage means for check and in a recording medium which can be dismounted from the information device when the storage medium is dismounted, agree with each other, and that allows supply of information such as navigation information only when these moving distance information agree with each other. The check means additionally checks at least one of difference between position information P1 stored in the storage medium when the storage medium is dismounted and present position information P2, and difference between day/time information T1 stored in the storage medium when the storage medium is dismounted and present day/time information T2, and allow supply of navigation information only when the checked results satisfy predetermined conditions.

### BACKGROUND OF THE INVENTION

1. Field of the Invention

The present invention relates to an information processing device, an information processing method and a storage medium, and in particular, to an information processing device, an information processing method and a storage medium that can prevent the illegal use of information utilized in a movable information processing device such as a vehicle mounted navigation device, a personal digital assistant and the like (hereinafter explanation will be given on a vehicle mounted navigation device as an example and the information is referred to as “map data”).

2. Description of the Related Art

The map data utilized in the vehicle mounted navigation device is stored in a hard disk drive (hereinafter referred to as “HDD”) of the device and in a case of updating the map data, the HDD is dismounted from the device and the map data is updated by the use of a unit specific to the manufacturer only by a manufacturer or by a sales outlet, then the HDD is mounted on the device again. A user uses the device including the HDD in which the updated map data is stored.

However, the HDD of vehicle mounted navigation device is usually such a product for general purpose use that is used as a peripheral device of a personal computer and the like. Hence, a user having abundant knowledge about software can illegally copy the updated map data from his own HDD to another person's HDD to gain profit or can illegally copy the updated map data from another person's HDD to his own HDD to acquire the updated map data with low price.

In a technical field different from a movable information processing device such as the vehicle mounted navigation device, the personal digital assistant and the like, in order to prevent the information of software from being illegally copied or in order to prevent software of evaluation version for which an expiration date of trial use is previously set by a contract from being illegally used after the expiration date, various countermeasures have been proposed.

For example, there is proposed a technology for preventing the illegal copy of expensive software used in a semiconductor manufacturing factory. According to this proposal, a technology includes acquisition means for acquiring day/time information and the position information of a predetermined device in which predetermined software is mounted, from an external source, determination means for determining whether or not the day/time information and the position information are within predetermined ranges read from the software, and program stop means for stopping executing of predetermined software in a case where the day/time information and the position information are not within the predetermined ranges.

With this arrangement, illegal copy of software that software is illegally copied and is used in a place other than a place where a licensed device is installed can be found from difference in the position information, or illegal use of software can be found by the difference between the expiration time and time that elapses after the expiration time. In these case of illegal copy or illegal use, the executing of program is stopped. Here, this is based on a premise that a program routine for inspecting the latitude and longitude information of the installation place and the day/time information of expiration of use is buried at the time of making a compiling link, in a range from several positions to several hundred positions of binary codes of the software program to be protected (for example, see patent document 1).

[Patent document 1] Japanese Unexamined Patent Publication No. 2001-282526 (paragraph number [0003], [0008], [0009], and [0034])

However, as a matter of fact, it is impossible to bury a program routine for inspecting the latitude and longitude information of the installation place and the day/time information of expiration of use for each user in the software program, from a viewpoint of cost in the case of map data used in the information processing device such as the vehicle mounted navigation device and the personal digital assistant. Moreover, the information processing device such as the vehicle mounted navigation device, the personal digital assistant and the like is based on a premise that they are made to use in mobile, so a program routine for inspecting a fixed position information of the device cannot be previously buried in the software program.

For this reason, there has been a problem that it is impossible to prevent the illegal copy of the map date used in the information processing device based on that it is made to use in mobile such as the vehicle mounted navigation device, the personal digital assistant and the like.

### SUMMARY OF THE INVENTION

The present invention has been made to solve the above problem. An object of the present invention is to provide a movable information processing device, an information processing method and a storage medium that can prevent illegal use of the map data with ease.

A movable information processing device in accordance with the present invention includes: a storage medium that is capable of storing information and being dismounted from the movable information processing device; information supply means that supplies information on a basis of information read from the storage medium; mount/dismount detection means that detects a state where the storage medium is dismounted and a state where the storage medium is again mounted; moving distance detection means that detects an accumulated moving distance of the movable information processing device; output means that outputs moving distance information acquired from the moving distance detection means to store in the storage medium and storage means for check when a state where the storage medium is dismounted, is detected by the mount/dismount detection means; and check means that checks whether or not the moving distance information stored in the storage medium agrees with the moving distance information stored in the storage means for check when the state where the storage medium is again mounted, is detected by the mount/dismount detection means and that allows the information supply means to supply updated information only in a case both of the moving distance information agree with each other.

Moreover, an information processing method in accordance with the present invention includes the steps of: detecting an accumulated moving distance of a movable information processing device till a storage medium is dismounted from the information processing device; outputting moving distance information detected by the step of detecting an accumulated moving distance to store in the storage medium and storage means for check; and checking whether or not the moving distance information stored in the storage medium agrees with the moving distance information stored in the storage means for check when the storage medium is again mounted, and allowing information supply means to supply updated information only in a case where both of the moving distance information agree with each other.

Therefore, according to the present invention, there is produced an effect of an information processing device and an information processing method that can easily prevent illegal use of the map data.

Furthermore, a storage medium in accordance with the present invention is capable of being dismounted from a movable information processing device and that stores as data for check an accumulated moving distance information of the information processing device when the storage medium is dismounted. Therefore, there is produced an effect of providing a storage medium that can facilitate the determination of illegal use of map data.

### BRIEF DESCRIPTION OF THE DRAWINGS

FIG. 1 is a conceptual diagram to show a function of the vehicle mounted navigation system in embodiment 1 of the present invention.

FIG. 2 is a flow chart to show the operation of navigation system in FIG. 1.

### DETAILED DESCRIPTION OF THE PREFERRED EMBODIMENT

Hereafter, one structure of preferred embodiment of the present invention will be described with reference to the drawings.

Embodiment 1

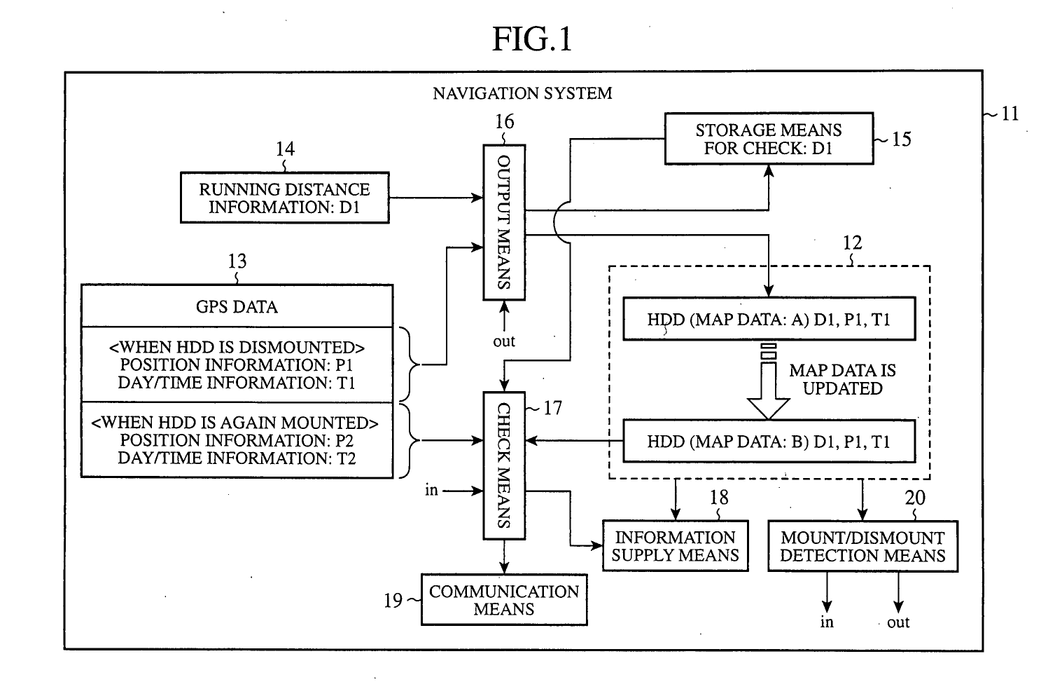

FIG. 1 is a conceptual diagram of the vehicle mounted navigation system (movable information processing device) 11 of embodiment 1 of the present invention and the conceptual diagram is to show function of the navigation system mounted in a vehicle as a moving body. An HDD (storage medium) 12 has an area to store map data and an area to store various kinds of information to be described below in a rewritable hard disk. In a case of updating the map data, the HDD 12 is dismounted from the navigation system 11 in a manufacturer or a sales outlet and the map data is updated by the use of a unit specific to the manufacturer, then the HDD is mounted on the device again. A user uses the device including the HDD in which the updated map data is stored.

A GSP detection part (position detection means, day/time detection means) 13 detects GSP data including present position information P output from a GSP receiver and present year/month/day/time information (hereinafter referred to as “day/time information”) T. This GSP data includes position information P1 and day/time information T1 when the HDD 12 is dismounted and position information P2 and day/time information T2 when the HDD 12 is again mounted. The HDD 12 has an area to store the position information P1 and the day/time information T1 in addition to the area to store the map data. A running distance detection part (running distance detection means) 14 detects and stores the accumulated running distance (hereafter referred to as “running distance”) information D1 of a vehicle. Storage means for check 15 has an area to store the running distance information D1. Output means 16 outputs the position information P1 and the day/time information T1 which are acquired from the GSP detection part 13 to store in the HDD 12 and outputs the running distance information D1 acquired from the running distance detection part 14 to store in the HDD 12 and the storage means for check 15.

Check means 17 checks the GSP data acquired from the GSP detection part 13 and the running distance information stored in the storage means for check 15 against the GSP data and the running distance information that are stored in the HDD 12. Information supply means 18 supplies navigation information based on the map data stored in HDD 12 to the user via a predetermined display and an audio unit (both not shown). Communication means 19 automatically sends a notification of illegal use to the sales outlet or the manufacturer of map data. Mount/dismount detection means 20 detects that the HDD 12 is dismounted and again mounted.

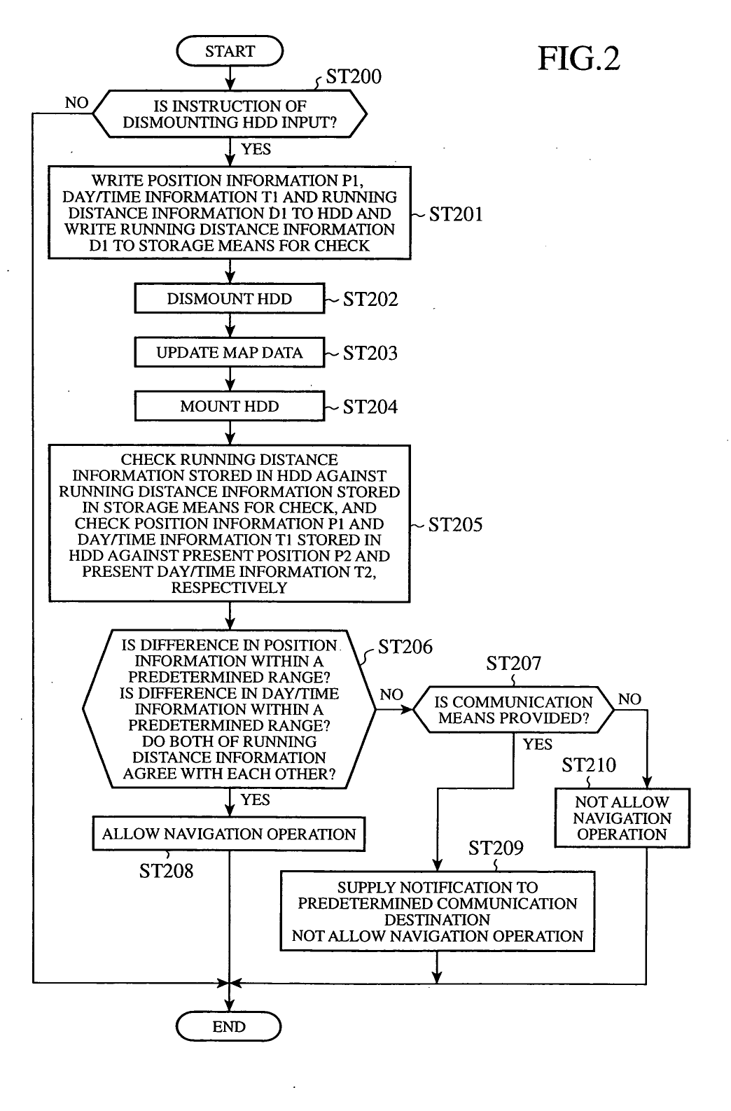

FIG. 2 is a flow chart to show flow in a case of updating the map data in the navigation system 11 in FIG. 1.

First, it is determined whether or not an instruction of dismounting the HDD 12 is input from an operating part (not shown) of the navigation system 11 (step ST200). When the instruction of dismounting the HDD 12 is input, the output means 16 outputs the position information P1 and the day/time information T1 that are GPS data acquired from the GPS detection part 13 and the running distance information D1 acquired from the running distance detection part 14 and writes them to the HDD 12 and writes the running distance information D1 to the storage means for check 15 (step ST201).

Then, the HDD 12 is dismounted from the navigation system 11 (step ST202), and map data is updated from the present map data A to new map data B (step ST203) and the HDD 12 is again mounted in the navigation system 11 (step ST204). The GPS detection part 13 detects and stores position information P2 (present position) and day/time information T2 (present time) that are GPS data when the HDD 12 is again mounted. When the check means 17 recognizes that the HDD 12 is again mounted by a detection of the mount/dismount detection means 20, the check means 17 checks the running distance information D1 stored in the HDD 12 against the running distance information stored in the storage means for check 15 and checks the position information P1 and day/time information T1 that are stored in the HDD 12 against present position P2 and present time T2 (step ST205).

Next, it is determined whether or not the difference between the position information P1 and the position information P2 is within a predetermined range (for example, within 100 m) and it is determined whether or not the difference between the day/time information T1 and the day/time information T2 is within a predetermined range (for example, within a range from 5 days to 9 days) and it is determined whether or not the running distance information stored in the storage means for check 15 agrees with the running distance information D1 stored in the HDD 12 (step ST206). In a case where the map data is updated by an authorized procedure by the manufacturer or by the sales outlet, both of the position information P1 and the position information P2 are the position information of the manufacturer or the sales outlet and hence the difference between the position information P1 and the position information P2 is 100 m or less at the largest, and the difference between the day/time information T1 when the HDD 12 is dismounted and the day/time information T2 when the HDD 12 is again mounted becomes about one week. Moreover, in a case where the HDD 12 is again mounted in the same navigation system as the user's navigation system from which the HDD 12 is dismounted, the running distance information stored in the storage means for check 15 accurately agrees with the running distance information D1 stored in the HDD 12.

In a case where all these three conditions are all satisfied, it is determined that there is no illegal use such as illegal copy and illegal transfer, so navigation operation is allowed (step ST208) and the information supply means 18 supplies the user with navigation information on a basis of the updated map data.

In a case where at least any one of these conditions is not satisfied at step ST206, it is determined whether or not the communication means is provided (step ST207). Since the communication means is provided in the structure of FIG. 1, a notification is supplied to a predetermined communication destination such as the sales outlet or the manufacturer and navigation operation is not allowed (step ST209). Even if the communication means is not provided, the navigation operation is not allowed (step ST210).

As described above, according to this embodiment 1, the movable information processing device is provided with: the HDD 12 that stores the map data; the information supply means 18 that supplies navigation information on a basis of the map data read from the HDD 12; the GPS detection part 13 that detects the position information P1 and P2 and the day/time information T1 and T2 when the HDD 12 is dismounted and when the HDD 12 is again mounted; the running distance detection part 14 that detects the running distance D1 of vehicle; the output means 16 that outputs the position information P1 and the day/time information T1 acquired from the GPS detection part 13 in the HDD 12 to store and outputs the running distance information acquired from the running distance detection part 14 in the HDD 12 and the storage means for check 15 to store; and the checking means 17 that checks whether or not the difference between the position information P1 stored in the HDD 12 and present position information P2 is within a predetermined range and whether or not the difference between the day/time information T1 stored in the HDD 12 and present day/time information T2 is within another predetermined range and checks whether or not the running distance information D1 stored in the HDD 12 agrees with the running distance information stored in the storage means for check 15 in a case where the map data of the HDD 12 is updated, and prohibits supplying the navigation information in a case where neither the difference in the position information nor the difference in the day/time information is within the predetermined range and where both of the running distance information do not agree with each other. Therefore, there is produced an effect of preventing the illegal use of map data with ease.

In this respect, in the above embodiment 1, in a case where all of three conditions are satisfied that the difference between the position information when the HDD 12 is dismounted and the position information when the HDD 12 is again mounted is within a predetermined range and that the difference between the day/time information when the HDD 12 is dismounted and the day/time information when the HDD 12 is again mounted is within another predetermined range and that the running distance information when the HDD 12 is dismounted agrees with the running distance information when the HDD 12 is again mounted, it is determined that the map data is not illegally used. However, as a modification of embodiment 1, it is also recommended that even in a case where the running distance information and at least one condition of the position information or the day/time information are satisfied, or in a case where only the condition of running distance information is satisfied, a determination be made that the map data is not illegally used to allow the supply of navigation information.

Further, the present position information P2 and the day/time information T2 change after the HDD 12 is dismounted, but the running distance information D1 once written to the storage means for check 15 and the HDD 12 do not change even after the HDD 12 is dismounted and after the HDD 12 is again mounted as long as new information is not written by the output means 16. Therefore, it is also recommended that the output means 16 does not write the running distance information D1 to the HDD 12 and the storage means for check 15, as is the case with the above embodiment 1, when an instruction of dismounting the HDD 12 is input from the operating part and the mount/dismount detection means 20 detects the HDD 12 being dismounted, but writes the running distance information D1 to the HDD 12 and the storage means for check 15 every time the vehicle moves a predetermined distance (for example, 1 km). In this case, even in a case where the instruction of dismounting the HDD 12 is not input from the operating part and the navigation system 11 has power supply turned off and the HDD 12 is dismounted, it is possible to check the running distance information stored in the HDD 12 against the running distance information stored in the storage means for check 15 when the HDD 12 is mounted again.

Still further, in the above embodiment 1, the information processing device of the present invention has been described as an example by taking the navigation system 11 mounted in the vehicle as a moving body, but the present invention is not limited only to the navigation system. The present invention can be applied also to an information processing device carried by a person as a mobile device such as mobile cellular phone, a phone of personal handy phone system (PHS), a personal digital assistant (PDA) and the like.

What is claimed is:

1. A movable information processing device comprising:
a storage medium that is capable of storing information and being dismounted from the movable information processing device;
information supply means that supplies information on a basis of information read from the storage medium;
mount/dismount detection means that detects a state where the storage medium is dismounted and a state where the storage medium is again mounted;
moving distance detection means that detects an accumulated moving distance of the movable information processing device;
output means that outputs moving distance information acquired from the moving distance detection means to store in the storage medium and storage means for check when a state where the storage medium is dismounted, is detected by the mount/dismount detection means; and
check means that checks whether or not the moving distance information stored in the storage medium agrees with the moving distance information stored in the storage means for check when the state where the storage medium is again mounted, is detected by the mount/dismount detection means and that allows the information supply means to supply updated information only in a case both of the moving distance information agree with each other.

2. The movable information processing device as claimed in claim 1, further comprising position detection means that detects present position of the movable information processing device, wherein
the output means further outputs position information P1 acquired from the position detection means to store in the storage medium when the state where the storage medium is dismounted, is detected by the mount/dismount detection means, and
the check means allows the information supply means to supply updated information further in a case where difference between the position information P1 stored in the storage medium and present position P2 is within a predetermined range when the state where the storage medium is again mounted is detected by the mount/dismount detection means.

3. The movable information processing device as claimed in claim 1, further comprising day/time detection means that detects present day and time, wherein
the output means further outputs day/time information T1 acquired from the day/time detection means to store in the storage medium when the state where the storage medium is dismounted, is detected by the mount/dismount detection means, and
the check means allows the information supply means to supply updated information further in a case where difference between the day/time information T1 stored in the storage medium and present day/time information T2 satisfies a predetermined condition when the state where the storage medium is again mounted, is detected by the mount/dismount detection means.

4. A movable information processing device comprising:
a storage medium that is capable of storing information and being dismounted from the information processing device;
information supply means that supplies information on a basis of information read from the storage medium;
mount/dismount detection means that detects a state where the storage medium is dismounted and a state where the storage medium is again mounted;
moving distance detection means that detects an accumulated moving distance of the information processing device;
position detection means that detects present position of the information processing device;
day/time detection means that detects present day and time;
output means that outputs moving distance information D1 acquired from the moving distance detection means to store in the storage medium and storage means for check, and outputs position information P1 acquired from the position detection means and day/time information T1 acquired from the day/time detection means to store in the storage means, when a state where the storage medium is dismounted, is detected by the mount/dismount detection means; and
check means that checks whether or not the moving distance information D1 stored in the storage medium agrees with the moving distance information stored in the storage means for check and whether or not difference between the position information P1 stored in the storage means and present position information P2 is within a predetermined range and whether or not difference between the day/time information T1 stored in the storage means and present day/time T2 is within another predetermined range when the state where the storage medium is again mounted, is detected by the mount/dismount detection means, and that allows the information supply means to supply updated information only in a case where all the checked results satisfy predetermined conditions respectively.

5. The movable information processing device as claimed in claim 4, further comprising communication means that communicates with an external point, wherein the communication means delivers a notification to this effect to a predetermined communication destination in a case where checked results do not satisfy the predetermined conditions.

6. The movable information processing device as claimed in claim 4, wherein the storage medium that is capable of being dismounted is a hard disk drive and information stored in the storage medium is map information.

7. An information processing method comprising the steps of:
detecting an accumulated moving distance of a movable information processing device till a storage medium is dismounted from the information processing device;
outputting moving distance information detected by the step of detecting an accumulated moving distance to store in the storage medium and storage means for check; and
checking whether or not the moving distance information stored in the storage medium agrees with the moving distance information stored in the storage means for check when the storage medium is again mounted, and allowing information supply means to supply updated information only in a case where both of the moving distance information agree with each other.

8. The information processing method as claimed in claim 7, further comprising the steps of:
detecting a position of the movable information processing device when the storage medium is dismounted from the information processing device; and
detecting a day/time when the storage medium is dismounted, wherein
the outputting step further includes steps of outputting the position information detected by the step of detecting a position and the day/time information detected by the step of detecting a day/time to store these information in the storage medium, and
the checking step further includes steps of checking whether or not difference between the position information stored in the storage means and present position information is within a predetermined range and whether or not difference between the day/time information stored in the storage means and present day/time is within another predetermined range, and allowing the information supply means to supply updated information only in a case where these two information satisfy predetermined conditions respectively.

9. A storage medium that is capable of being dismounted from a movable information processing device and that stores as data for check an accumulated moving distance information of the information processing device when the storage medium is dismounted.

10. The storage medium as claimed in claim 9, wherein at least one of position information and day/time information when the storage medium is dismounted, are further stored as data for check.
